(19) United States
(12) Patent Application Publication
(10) Pub. No.: US 2020/0342787 A1
(43) Pub. Date: Oct. 29, 2020

(54) METHOD AND APPARATUS FOR DECRYPTING CRYPTOGRAM USING AUXILIARY SECRET KEY

(71) Applicants: ELECTRONICS AND TELECOMMUNICATIONS RESEARCH INSTITUTE, Daejeon (KR); INJE UNIVERSITY INDUSTRY-ACADEMIC COOPERATION FOUNDATION, Gimhae-si (KR)

(72) Inventors: Hyung Kyu LEE, Daejeon (KR); Nam Yong LEE, Busan (KR); Hea Sook PARK, Daejeon (KR)

(73) Assignees: ELECTRONICS AND TELECOMMUNICATIONS RESEARCH INSTITUTE, Daejeon (KR); INJE UNIVERSITY INDUSTRY-ACADEMIC COOPERATION FOUNDATION, Gimhae-si (KR)

(21) Appl. No.: 16/856,846

(22) Filed: Apr. 23, 2020

(30) Foreign Application Priority Data
Apr. 23, 2019 (KR) 10-2019-0047553

(51) Int. Cl. G09C 1/00; H04L 9/06; H04L 9/32

(52) U.S. Cl. CPC G09C 1/00; H04L 9/0625; H04L 2209/12; H04L 9/3247; H04L 9/0631

(57) ABSTRACT

An apparatus and a method for decrypting cryptogram through steps of: dividing a cryptogram received from a server into a first cryptogram and a second cryptogram; transforming the first cryptogram and the second cryptogram by using a predetermined inverse transform; and decrypting the cryptogram to generate a plaintext based on a Feistel network including XOR operations between the transformed first cryptogram and a round key generated from a secret key and between the transformed second cryptogram and the round key are provided.

### CROSS-REFERENCE TO RELATED APPLICATION

This application claims priority to and the benefit of Korean Patent Application No. 10-2019-0047553 filed in the Korean Intellectual Property Office on Apr. 23, 2019, the entire contents of which are incorporated herein by reference.

### BACKGROUND OF THE INVENTION

### (a) Field of the Invention

The present description relates to a method and an apparatus for decrypting cryptogram by using an auxiliary secret key.

### (b) Description of the Related Art

A block cipher is a symmetric key cipher that encrypts/decrypts a message into block units. For example, the data encryption standard (DES) is a cryptographic algorithm set by the National Bureau of Standards (NBS) in 1975 as a national standard. It is a block cipher that encrypts/decrypts a 64-bit block into a 64-bit block by using a secret key with a length of 56 bits. The Advanced Encryption Standard (AES) is a cryptographic algorithm defined as the next generation cryptographic standard instead of DES by the National Institute of Standards and Technology (NIST) in 2001, and is a block cipher that encrypts/decrypts a 128-bit block into a 128-bit block by using a secret key with a length of 128, 192, or 256 bits. A SEED is a block cipher algorithm developed at the Korea Information Protection Center in 1999. It encrypts/decrypts a 128-bit block into a 128-bit block by using a secret key with a length of 128 or 256 bits.

On the other hand, whitebox cryptography is a technique that makes the algorithm a large lookup table and conceals the cryptographic keys in the lookup table in a mixed state with a cryptographic algorithm implemented in software, so that it is not easy to infer the cryptographic key even when analyzing the internal operation. Traditional cryptographic mechanisms work under the assumption that the cryptographic keys are securely maintained on a blackbox device (a trusted terminal). However, the white box encryption mechanism operates under the assumption that the encryption key is not easily seen even when encryption/decryption is performed in an untrusted terminal because the encryption key is obfuscated in a software-implemented encryption algorithm. That is, the whitebox encryption technology is a technology that can safely store the encryption key with only software and prevent the encryption key from being revealed even when an encryption algorithm is executed in the untrusted terminal.

As a study case of white box cryptography implementation, S. Chow, P. Eisen, H. Johnson, and P. C. van Oorschot presented a method to apply whitebox cryptography to the AES and the DES algorithms. The method is composed of transforming the entire decryption process into LUTs (LookUp Tables) that depend on a series of secret keys, and concealing the secret key itself into the program. In the method proposed by S. Chow et al., to increase safety related to secret key concealment, an arbitrary random bijection was randomly inserted into the decrypting algorithm to complicate the entire program.

What was revealed in the attack on the method proposed by S. Chow et al. is that the method presented by S. Chow et al. cannot safely conceal the secret key. Accordingly, along with the question of the possibility of the existence of a white box password, a proposal was proposed to lower the condition of the white box password to a realistic level. For example, a scheme that makes it difficult to extract the secret key from the program through reverse engineering by Program Obfuscation and a scheme that makes it impossible to realistically attempt an attack that extract the secret key by using an enormous search space to be considered for the key extraction have been proposed.

A realistic threat to the whitebox cryptography is an attack method that calls the entire program a secret key, called code lifting. The code lifting method does not extract the secret key from the white box encrypted program, but considers the entire program as the secret key and attacks the whitebox cryptography. For example, if the decrypting program should be used only in a specific terminal and cannot be used in another terminal, the secret key hidden in the decrypting program need not be extracted. This is because the decrypting program itself acts as the secret key. To prepare for such an attack, a node-locking method can be used. The node-locking is a method that links specific information of terminal (e.g., network device's MAC address) with the program's operation position. That is, the specific information of the terminal can be used only in a predetermined geographic position. In this case, it is essential to hide the part that calls the specific information of the interlocked terminal through program obfuscation.

On the other hand, if the node-locking method is used, a location limiting effect can be obtained for a code lifting attack against the decrypting program in which the secret key is hidden, but a time limiting effect cannot be obtained. The time limit is required, for example, in a service environment in which a fee is charged according to the number of times the data stored encrypted in the terminal is played. When data stored in encrypted state in the user's terminal is M^{(j)}, j=1, . . . N, the decrypting key X^{(j)} is downloaded from the server in order that M^{(j)} is to be played. When the decrypting key is downloaded, the charging can be done. The decrypting key X^{(j)} is downloaded in the form of Y^{(j)}=D_{K}(Y^{(j)}), encrypted by the secret key K. The user extracts X^{(j)}=D_{K}(Y^{(j)}) by using the decrypting program in which the secret key K installed in the terminal is hidden and decrypts the encrypted data. At this time, it is necessary to prevent users from reusing Y^{(j)} downloaded in the past to play the encrypted data M^{(j)} without paying the usage fee.

That is, if there is no ‘time limit’ function for the decrypting program in which the secret key is hidden, the user can perform decrypting by using a downloaded program. This is an example of a successful code-lifting attack because the effect of having the secret key is obtained even if the secret key is unknown.

The above information disclosed in this Background section is only for enhancement of understanding of the background of the invention, and therefore it may contain information that does not form the prior art that is already known in this country to a person of ordinary skill in the art.

### SUMMARY OF THE INVENTION

An exemplary embodiment provides an apparatus for decrypting cryptogram by using an auxiliary secret key.

Another embodiment provides a method for decrypting cryptogram by using an auxiliary secret key.

According to an exemplary embodiment, a decrypting apparatus in a block cipher system is provided. The decrypting apparatus includes: a processor, a memory, and a wireless communication unit, wherein the processor executes a program stored in the memory to perform:

dividing a cryptogram received from a server through the wireless communication unit into a first cryptogram and a second cryptogram;

transforming the first cryptogram and the second cryptogram by using a predetermined inverse transform,

decrypting the cryptogram to generate a plaintext based on a Feistel network including XOR operations between the transformed first cryptogram and a round key generated from a secret key and between the transformed second cryptogram and the round key,

wherein the predetermined inverse transform is an inverse of a transform determined based on an auxiliary secret key having a same size as A size of the cryptogram and electronic signature, and the Feistel structure includes n round operations and n is a natural number.

When the processor performs the step of the transforming, the processor may perform transforming the first cryptogram and the second cryptogram by using the predetermined inverse transform and by reading a lookup table (LUT) from the memory, and the XOR operations includes a first XOR operation between the transformed first cryptogram and the round key and a second XOR operation between the transformed second cryptogram and the round key.

The LUT may be included in the program to indicate a combination of the XOR operations and the predetermined inverse transform.

The LUT may include a plurality of 3D arrays, and the plurality of 3D arrays may be included in the program in a LUT scrambling manner based on ordering of if statements and variable renaming.

The processor may execute the program to further perform receiving the electronic signature from the server through the wireless communication unit, wherein the electronic signature is determined based on intermediate calculation result of the plaintext, an identifier of a user using the decrypting apparatus, time information, and a value derived from the electronic signature of the server.

The processor may execute the program to further perform determining whether to continue the decrypting by checking the electronic signature of the server.

When the processor performs decrypting the cryptogram into a plaintext based on a Feistel network including XOR operations between the transformed first cryptogram and a round key generated from a secret key and between the transformed second cryptogram and the round key, the processor may perform:

performing, in a 2m^{th} round, a first XOR operation between one output of a 2m+1^{th} round and a 2m+1^{th} round key;

applying an inverse transformation corresponding to the 2m+1^{th} round to a result of the first XOR operation; and

performing a second XOR operation between a result of the inverse transformation and a 2m−1^{th} round key,

wherein m is a natural number and 2m+1 is less than n.

When the processor performs decrypting the cryptogram into a plaintext based on a Feistel network including XOR operations between the transformed first cryptogram and a round key generated from a secret key and between the transformed second cryptogram and the round key, the processor may further perform:

inputting a result of the second XOR operation to a round function corresponding to the 2m^{th} round in the 2m^{th} round; and

performing a third XOR operation between an output of the round function and one output of the 2m^{th} round.

The round function may have the same length as the first cryptogram, and all elements in the round function may be 0.

k₀ and k₁ of the round key may be 0, and the k0 and k1 may be used in an XOR operation performed at a last even numbered round.

According to another exemplary embodiment, a decrypting method in a block cipher system is provided. The method includes:

dividing a cryptogram received from a server into a first cryptogram and a second cryptogram;

transforming the first cryptogram and the second cryptogram by using a predetermined inverse transform,

decrypting the cryptogram to generate a plaintext based on a Feistel network including XOR operations between the transformed first cryptogram and a round key generated from a secret key and between the transformed second cryptogram and the round key,

wherein the predetermined inverse transform is an inverse of a transform determined based on an auxiliary secret key having a same size as A size of the cryptogram and electronic signature, and the Feistel structure includes n round operations and n is a natural number.

The transforming the first cryptogram and the second cryptogram by using a predetermined inverse transform may include transforming the first cryptogram and the second cryptogram by using a lookup table (LUT) indicating a combination of the XOR operations and the predetermined inverse transform, and the LUT is included in a decrypting program.

The LUT may include a plurality of 3D arrays, and the plurality of 3D arrays may be included in the decrypting program in a LUT scrambling manner based on ordering of if statements and variable renaming.

The decrypting method may further include:

receiving the electronic signature from the server through the wireless communication unit, wherein the electronic signature may be determined based on intermediate calculation result of the plaintext, an identifier of a user using the decrypting apparatus, time information, and a value derived from the electronic signature of the server.

The decrypting method may further include determining whether to continue the decrypting by checking the electronic signature of the server.

The decrypting the cryptogram into a plaintext based on a Feistel network including XOR operations between the transformed first cryptogram and a round key generated from a secret key and between the transformed second cryptogram and the round key may include:

performing, in a 2m^{th} round, a first XOR operation between one output of a 2m+1^{th} round and a 2m+1^{th} round key;

applying an inverse transformation corresponding to the 2m+1^{th} round to a result of the first XOR operation; and

performing a second XOR operation between a result of the inverse transformation and a 2m−1^{th} round key,

where m is a natural number and 2m+1 is less than n.

The decrypting the cryptogram into a plaintext based on a Feistel network including XOR operations between the transformed first cryptogram and a round key generated from a secret key and between the transformed second cryptogram and the round key may further include:

inputting a result of the second XOR operation to a round function corresponding to the 2m^{th} round in the 2m^{th} round; and

performing a third XOR operation between an output of the round function and one output of the 2m^{th} round.

The round function may have the same length as the first cryptogram, and all elements in the round function may be 0.

k₀ and k₁ of the round key may be 0, and the k0 and k1 may be used in an XOR operation performed at a last even numbered round.

### BRIEF DESCRIPTION OF THE DRAWINGS

FIG. 1 is a flowchart illustrating an encryption method of 128 bit plaintext using a SEED encryption algorithm according to an exemplary embodiment.

FIG. 2 is a schematic diagram illustrating the F function of the SEED password in FIG. 1.

FIG. 3 is a flowchart illustrating a decrypting method of a 128 bit cryptogram using a SEED cryptographic algorithm according to an exemplary embodiment.

FIG. 4 is a flowchart illustrating an encryption process using DES cryptograph according to an exemplary embodiment.

FIG. 5 is a flowchart illustrating a decryption process using DES cryptograph according to an exemplary embodiment.

FIG. 6 is a schematic diagram illustrating the f function of the DES cryptograph according to an exemplary embodiment.

FIG. 7 is a schematic diagram illustrating the f* function, which is a modification of the f function in FIG. 6.

FIG. 8 is a flowchart illustrating an encrypting/decrypting method using an AES encryption algorithm according to an exemplary embodiment.

FIG. 9 is a flowchart illustrating a SEED encryption algorithm according to an exemplary embodiment.

FIG. 10 is a flowchart illustrating a SEED decrypting algorithm according to an exemplary embodiment.

FIG. 11 is a flowchart illustrating an eSEED decrypting algorithm according to an exemplary embodiment.

FIG. 12 is a schematic diagram illustrating the transformation Pᵢ of the eSEED decrypting algorithm according to an exemplary embodiment.

FIG. 13 is a schematic diagram illustrating the combination between the XOR operation and the inverse transformation Qᵢ of the eSEED decrypting algorithm according to the exemplary embodiment.

FIG. 14 is a schematic diagram illustrating an eDES encryption method according to an exemplary embodiment.

FIG. 15 is a schematic diagram illustrating an eDES decrypting method according to an exemplary embodiment.

FIG. 16 is a schematic diagram illustrating a transformation function of the eDES encryption method and a combination between the transformation function and the round key kᵢ according to an exemplary embodiment.

FIG. 17 is a schematic diagram illustrating a combination method between the transformation function of another eDES encryption method and the round key kᵢ according to another exemplary embodiment.

FIG. 18 is a block diagram illustrating a decrypting apparatus according to an exemplary embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope of the present description.

Accordingly, the drawings and description are to be regarded as illustrative in nature and not restrictive, and like reference numerals designate like elements throughout the specification. In this specification, redundant description of the same constituent elements is omitted.

Also, in this specification, it is to be understood that when one component is referred to as being “connected” or “coupled” to another component, it may be connected or coupled directly to the other component or may be connected or coupled to the other component with another component intervening therebetween.

On the other hand, in this specification, it is to be understood that when one component is referred to as being “connected or coupled directly” to another component, it may be connected or coupled to the other component without another component intervening therebetween.

It is also to be understood that the terminology used herein is only used for the purpose of describing particular embodiments, and is not intended to limit the invention. Singular forms are to include plural forms unless the context clearly indicates otherwise. It will be further understood that terms “comprises” and “have” used in the present specification specify the presence of stated features, numerals, steps, operations, components, parts, or a combination thereof, but do not preclude the presence or addition of one or more other features, numerals, steps, operations, components, parts, or a combination thereof.

Also, as used herein, the term “and/or” includes any plurality of combinations of items or any of a plurality of listed items. In the present specification, “A or B” may include “A”, “B”, or “A and B”.

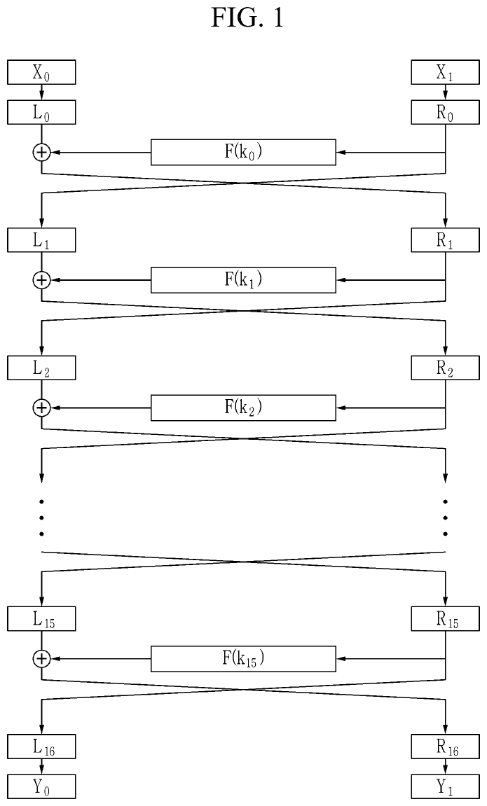

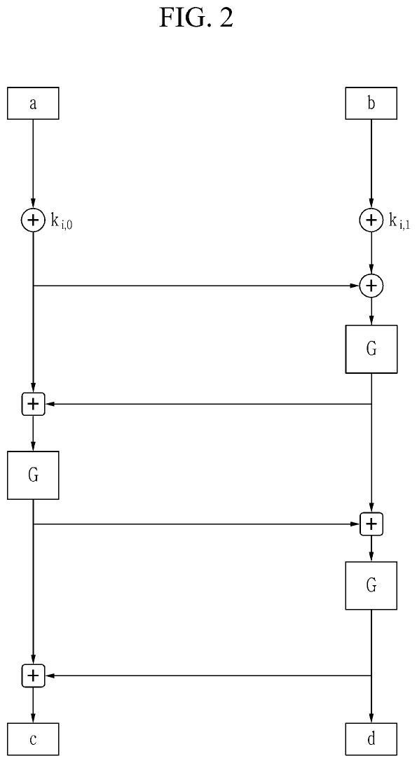

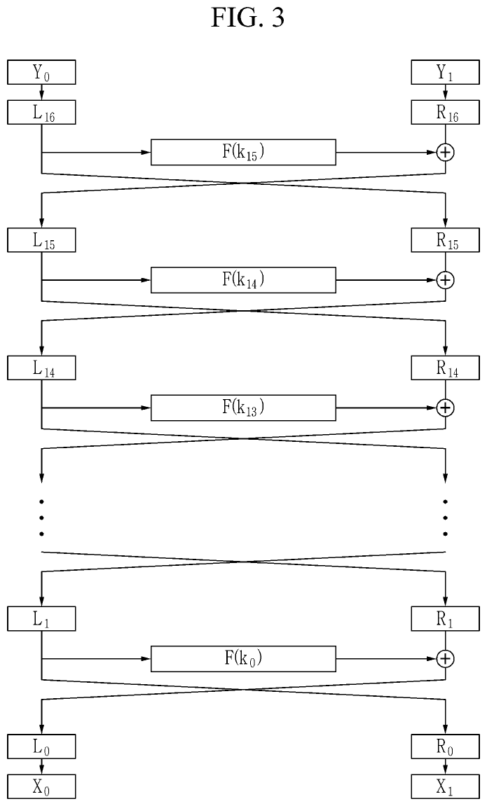

FIG. 1 is a flowchart illustrating an encryption method of 128 bit plaintext using a SEED encryption algorithm according to an exemplary embodiment, FIG. 2 is a schematic diagram illustrating the F function of the SEED password in FIG. 1, and FIG. 3 is a flowchart illustrating a decrypting method of a 128 bit cryptogram using a SEED cryptographic algorithm according to an exemplary embodiment.

In FIG. 1, an encryption device according to an exemplary embodiment may transform a 128-bit plaintext X=(X₀, X₁) into a 128-bit cryptogram Y=Y₀,Y₁) by sequentially applying 16 round keys kᵢ, i=0, . . . , 15 (for example, 64 bits) of secret key K to a round encryption process.

In Equation 1, an encryption function E which encrypts the given plaintext X may generate a cryptogram Y according to the secret key K. In modern cryptography, the security related to cryptogram is focused on the security of the cryptographic key K.

Y=E_{K}(X) [Equation 1]

The structure of a decryption function D that outputs the plaintext X by decrypting the cryptogram Y is the same as that of the encryption function E. The decryption function D is a function having a secret key like the encryption function E, and may perform a different decryption process according to the secret key. The secret key used in the encryption process may be also used in the decryption process in a symmetric key encryption algorithm.

X=D_{K}(Y) [Equation 2]

In Equation 2, K is the secret key used for the decrypting.

The structure of a block cipher SEED using 128-bit secret key is as follows. First, 16 round keys kᵢ, i=0, . . . , 15 whose length is 64-bit long may be calculated from the 128-bit secret key K based on a Roundkey generation method of Equation 3.

$$Roundkey Generation \text{:} \\ for ( i = 0 ; i < 16 ; i ++ ) \{ \\ {k}_{i , 0} = G ( e + g - {C}_{i} ) ; \\ {k}_{i , 1} = G ( f - h + {C}_{i} ) ; \\ if i \% 2 == 1 \\ e \vert \vert f + ( e \vert \vert f ) >> 8 ; \\ else \\ g \vert \vert h = ( g \vert \vert h ) << 8 ; \\ \} \qquad [ Equation 3 ]$$

In Equation 3, e, f, g, and h are 32-bit bit strings, respectively, and are part of the secret key K, respectively. That is, K=(e, f, g, f). In addition, In Equation 3, ∥ denotes concatenation of the bit strings, and » and « denote a shift of the bit strings. In Equation 3, ‘»8’ indicates that the bit string is shifted by 8 bits to the right, and ‘«8’ indicates that the bit string is shifted by 8 bits to the left.

In Equation 3, k_{i,0} and k_{i,1} may mean left 32 bits and right 32 bits of the 64 bit round key kᵢ, respectively. The 32-bit constant Cᵢ, i=0, . . . , 15 used in the Roundkey generation of Equation 3 and description of a G function that transforms 32-bit to 32-bit follow the Information communication organization standard TTAS.KO-12.0004/R1.

FIG. 1 illustrates a SEED encryption algorithm that encrypts 128-bit input plaintext X=(X₀,X₁) into 128-bit output cryptogram Y=(Y₀,Y₁) by using 16 round keys kᵢ, i=0, . . . , 15. FIG. 1 may be expressed as Equation 4.

$$Encryption by SEED \text{:} \\ {L}_{0} = {X}_{0} ; \\ {R}_{0} = {X}_{1} ; \\ for ( i = 0 ; i < 16 ; i ++ ) \{ \\ {L}_{i + 1} = {R}_{i} ; \\ {R}_{i + 1} = F ( {k}_{i} , {R}_{i} ) ⊕ {L}_{i} ; \\ \} \\ {Y}_{0} = {L}_{16} ; \\ {Y}_{1} = {R}_{16} ; \qquad [ Equation 4 [$$

In Equation 4, F(kᵢ) is a function that transforms 64 bits to 64 bits and is called a Feistel function. In the SEED cryptosystem, F function is a function that performs an exclusive OR (XOR, expressed as ⊕ in the drawings) operation between input data and a 64-bit round key kᵢ. The F function may output a result as Equation 5 below.

F(k, x)=F(0,x⊕k) [Equation 5]

According to Equation 5, the applying of the F(k) function to the input x of 64 bits and the round key k of 64 bits may be the same as the applying of the XOR operation result of 64 bits of x and 64 bits of k to F(0) function having 64 bits of 0 as the round key. The proof of Equation 5 is apparent from the description of F function in FIG. 2. Referring to FIG. 2, first, exclusive OR operations are performed on a 32-bit bit strings a and b, k_{i,0} of left 32 bits of the 64-bit round key kᵢ, and k_{i,1} of right 32 bits of the 64-bit round key kᵢ, respectively. Subsequently, 32-bit bit strings of c and d are calculated through the calculation using the G function. Here, [symbol] is an addition of 2³² coset between integers expressed in 32 bits.

In FIG. 3, the cryptogram Y=(Y₀,Y₁) of 128-bit may be transformed to the plaintext X=(X₀,X₁) of 128-bit based on the round key kᵢ, i=15, 14, . . . , 0 of the secret key K. FIG. 3 may be expressed as Equation 6.

$$Decryption by SEED \text{:} \\ {L}_{16} = {Y}_{0} ; \\ {R}_{16} = {Y}_{1} ; \\ for ( i = 0 ; i < 16 ; i ++ ) \{ \\ {L}_{16 - i - 1} = F ( {k}_{16 - i - 1} , {L}_{16 - i } ) ⊕ {R}_{16 - i} ; \\ {R}_{16 - i - 1} = {L}_{16 - i} ; \\ \} \\ {X}_{0} = {L}_{0} ; \\ {X}_{1} = {R}_{0} ; \qquad [ Equation 6 ]$$

On the other hand, block cipher DES, which processes data in a 64-bit unit using a secret key whose length is 56 bits, may have almost the same structure except for the SEED and Feistel functions.

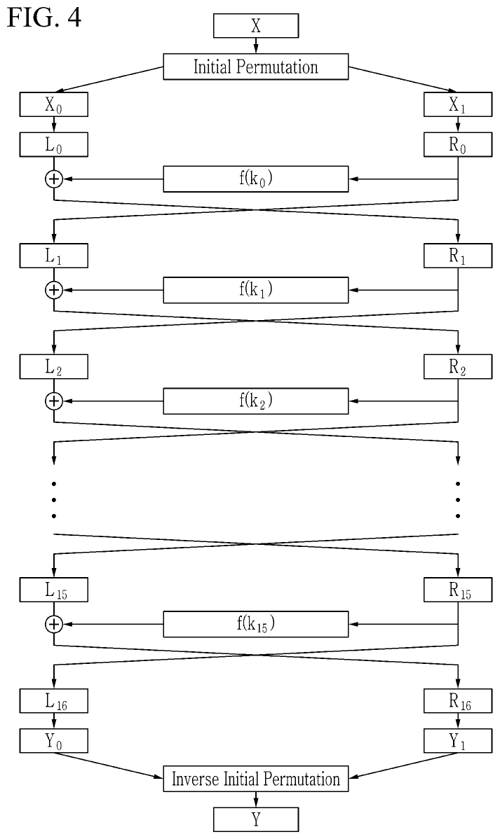

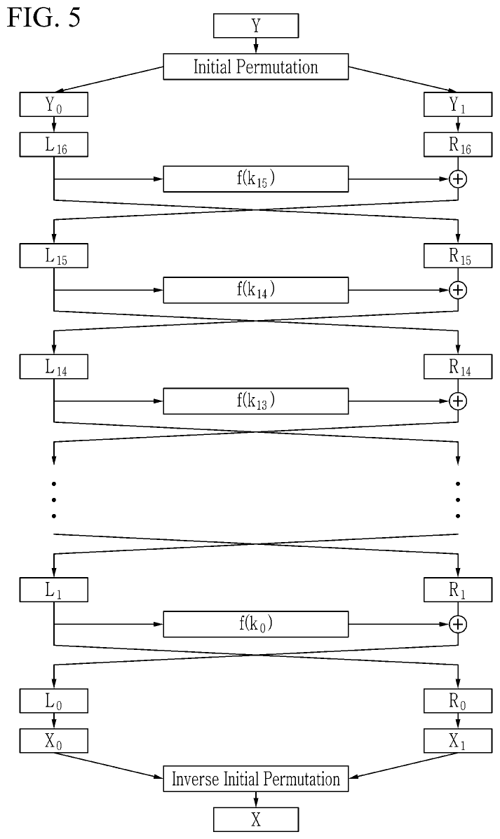

FIG. 4 is a flowchart illustrating an encryption process using DES cryptograph according to an exemplary embodiment and FIG. 5 is a flowchart illustrating a decryption process using DES cryptograph according to an exemplary embodiment.

Referring to FIG. 4, in the encryption process using the DES cryptograph, an initial permutation operation representing a one-to-one transformation between a 64-bit string and a 64-bit string is added to the encryption process of FIG. 1. Referring to FIG. 5, in the decryption process using the DES cryptograph, an inverse initial permutation operation representing a one-to-one inverse transformation between a 64-bit string and a 64-bit string is added to the decryption process of FIG. 3. That is, the encryption process may be expressed by Equation 4, and the decryption process may be expressed by Equation 6. The difference from the SEED encryption lies in that the DES performs the encryption and the decryption in 64-bit units, and the length of the round key of the DES encryption is 48 bits.

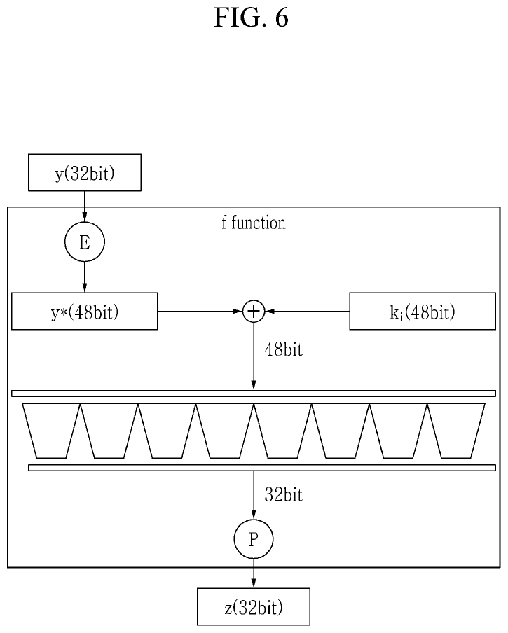

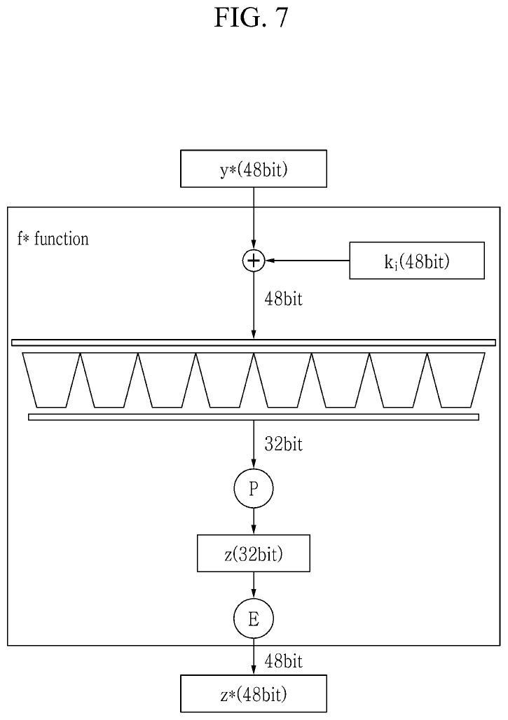

FIG. 6 is a schematic diagram illustrating the f function of the DES cryptograph according to an exemplary embodiment and FIG. 7 is a schematic diagram illustrating the f* function, which is a modification of the f function in FIG. 6.

Referring to FIG. 6, The Feistel function (f function) of the DES encryption algorithm may transform an input of the 32-bit string to an output of the 32-bit string. First, the f function may expand the input of the 32-bit to 48 bits (E in FIG. 6), and perform XOR operation on the extended input of the 48-bit and the round key kᵢ of 48-bit. Subsequently, a result of 32-bit string is output using an S-Box (eight trapezoid shapes in FIG. 6), and a 32-bit permutation P is finally applied to the 32-bit string result. The f* function is defined below by modifying the Feistel function f of the DES in FIG. 6. The f* function is shown as in FIG. 7 and may be expressed as Equation 7.

f*(kᵢ, E(y))=E(f(kᵢ, y)) [Equation 7]

Referring to Equation 7 and FIG. 7, in the f* function, the input is expanded to 48 bits in advance from the outside, and when a 32-bit result is output from the permutation P, the 32-bit result is expanded to 48 bits through the expansion transform E. The transform D may be used to represent the left inverse transform of the expansion transform E. Here, ‘the left inverse transform D of E’ is a transformation that transforms a 48-bit string to a 32-bit string and means “‘D(E(a))=a’ holds for any 32-bit a, but ‘E(D(b))=b’ does not hold for any 48-bit b”. The expansion transform E and its left inverse transform D are different from the encryption function E and the decryption function D.

Block cipher AES that processes data in a unit of 128-bit may use a secret key of 128 bits, 192 bits, or 256 bits. In the block cipher AES, the number of rounds may vary depending on the length of the secret key. The following describes the AES algorithm through an exemplary embodiment in which the 128-bit secret key is used.

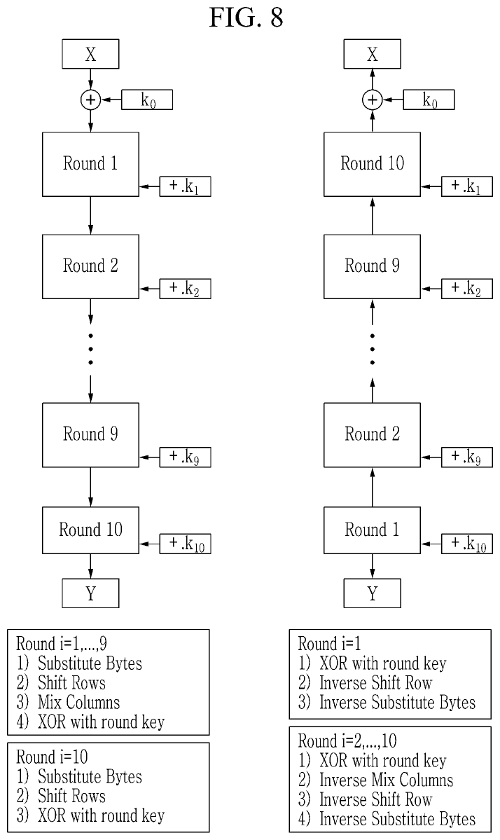

FIG. 8 is a flowchart illustrating an encrypting/decrypting method using an AES encryption algorithm according to an exemplary embodiment.

Referring to FIG. 8, the AES encryption process using a 128-bit secret key includes 10 rounds, and the end of each round is an XOR operation with a round key kᵢ whose length is 128 bits. In addition, the decryption process of the AES may also include 10 rounds, and the first part of each round is an XOR operation with a round key kᵢ. The symbol +. is used instead of the XOR symbol ⊕. The length of the round key kᵢ, i=0, 1, . . . , 10 is 128 bits.

In the case of the block ciphers, the encryption and the decryption are inverse relations to each other, and the structures are generally the same. The following describes the encryption process and the decryption process separately for convenience of explanation. In the present description, the encryption process may be performed in a controlled environment such as a cloud server, and the decryption process may be performed in an open terminal environment of the client. The encryption process by the SEED encryption system in the cloud server is as follows.

First, the encryption function E may generate a round key kᵢ, i=0, . . . , 15 by using the secret key K and obtain a result block Y=(Y₀,Y₁) from the input block X=(X₀,X₁) by using the generated round key. Equation 1 shows this.

On the client's side, the encryption function E may be seen as a blackbox where Y=(Y₀,Y₁) is output when X=(X₀,X₁) is input. That is, the client cannot know the form in which the encryption function E is implemented. The E, which is composed of an open algorithm, is named ‘blackbox’ because the client cannot obtain information about the round key kᵢ, i=0, . . . , 15 calculated from the secret key K or secret key K, which can determine the result of E.

The following describes the decryption process of the block cipher performed in the client's terminal. If, like the encryption process of the server, the decryption function D also generates a round key kᵢ from the secret key K and obtains the result X=(X₀,X₁) by using the generated round key and the block Y=(Y₀,Y₁) to be decrypted (i.e., Equation 2), an attacker can easily steal information about the secret key K or the round key kᵢ by applying memory hacking and reverse engineering techniques to the open environment of the terminal of the client where the decryption program is installed. The state in which the attacker can easily steal the secret key K or the round key kᵢ of the decryption process from the client terminal is called a ‘white box’. At this time, the white box encryption means an algorithm that does not expose the secret key, or the round key, or the entire process of the decryption from memory hacking and reverse engineering attacks.

The realistic conditions of the white box encryption are as follows.

a) When considering the search space size to be considered for program obfuscation and secret key extraction, extracting the hidden secret key from the decrypting program should not be possible upon a realistic reverse engineering analysis and memory hacking.

b) The decrypting program in which the secret key is hidden has a ‘location limitation’. That is, the decrypting program in which the secret key is hidden should be operated only in the specific terminal.

c) Software that implements the decrypting program in which the secret key is hidden has a ‘time limit’. That is, only the currently permitted data among the encrypted data transmitted from the server can be decrypted. The present description will be described below using the following rules and an 8-bit operation.

Any 8-bit bit string α=(α₇, . . . , α₀) (αᵢ=0 or 1) is considered an element of the Ring Z₂₅₆ or Galois Filed GF(2⁸) (where the maximal polynomial defining the finite field is m(x)=x⁸+x⁴+x³+x+1). In other words, it may be expressed by Equation 8 that any 8-bit bit string α=(α₇, . . . , α₀) (αᵢ=0 or 1) is an element of a Ring Z₂₅₆.

α=α₇2⁷+α₆2⁶+ . . . +α₀2⁰ [Equation 8]

In addition, the multiplication (Δ) and addition (+) operations between two 8-bit bit strings α and β may be defined as Equations 9 and 10 below.

α×β=αβ mod 2⁸ [Equation 9]

α+β=α+β mod 2⁸ [Equation 10]

The left + used In Equation 10 may represent the addition operation in the Ring Z₂₅₆, and the right + may represent the normal addition.

Further, that α=(α₇, . . . , α₀) is an element of the Galois field may be expressed as Equation 11.

α=α₇x⁷+α₆x⁶+ . . . +α₀x⁰ [Equation 11]

At this time, the multiplication (⊗) and addition (⊕) operations between the two 8-bit bit strings α and β may be defined as Equation 12 and Equation 13 below.

α⊗β=(α₇x⁷+ . . . +α₀x⁰)(β₇x⁷+ . . . +β₀x⁰)mod m(x) [Equation 12]

α⊕β=(α₇x⁷+ . . . +α₀x⁰)⊕(β₇x⁷+ . . . +β₀x⁰)mod m(x) [Equation 13]

In Equation 13, ⊕ shows the same operation as XOR.

When the 8-bit bit string α=(α₇, . . . , α₀) is regarded as an element of the Ring Z₂₅₆ or as an element of the Galois field GF(2⁸), α₀ of the α=(α₇, . . . , α₀) may mean the lowermost bit (Least Significant Bit, LSB).

Any 64-bit bit string x may include eight 8-bit bit strings x⁽⁷⁾, . . . , x⁽⁰⁾. That is, a 64-bit bit string x may be expressed as Equation 14.

x=(x⁽⁷⁾, . . . , x⁽⁰⁾) [Equation 14]

The operations between 64-bit bit strings may be defined as the operations between 8-bit component elements. That is, Equations 15 to 18 may be established for two 64-bit bit strings x and y.

x×y=(x⁽⁷⁾×y^{(y)}, . . . , x⁽⁰⁾×y⁽⁰⁾) [Equation 15]

x+y=(x⁽⁷⁾+y⁽⁷⁾, . . . , x⁽⁰⁾+y⁽⁰⁾) [Equation 16]

x⊗y=(x⁽⁷⁾⊗y^{(y)}, . . . , x⁽⁰⁾⊗y⁽⁰⁾) [Equation 17]

x⊕y=(x⁽⁷⁾⊕y⁽⁷⁾, . . . , x⁽⁰⁾⊕y⁽⁰⁾) [Equation 18]

At this time, the LSB of 64 bits x is the LSB of eight 8-bit component elements. For example, Equation 19 may be established.

x [symbol] LSB=(1, . . . , 1) ⇔x₀^{(j)}=1, j=7, 6, . . . , 0 [Equation 19]

In the following description, the operation between 32-bit, 48-bit, and 128-bit bit strings is defined by the methods of Equations 15 to 19.

The method for implementing the whitebox block cipher using an auxiliary secret key according to an exemplary embodiment may modify the algorithm of the conventional block cipher, so that the round key generated from the secret key is safely hidden inside the decrypting program of the block cipher. According to an exemplary embodiment, eSEED is a modified algorithm of the SEED algorithm. According to another exemplary embodiment, eDES is a modified algorithm of the DES algorithm. According to yet another exemplary embodiment, eAES is a modification of the AES algorithm.

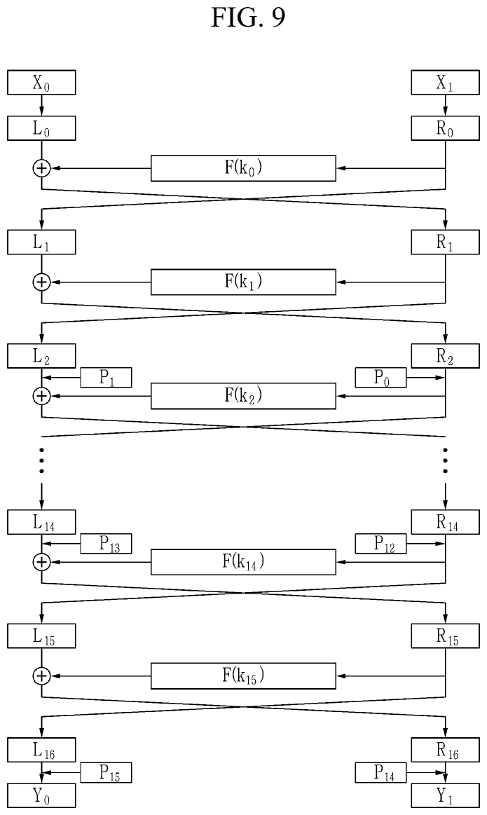

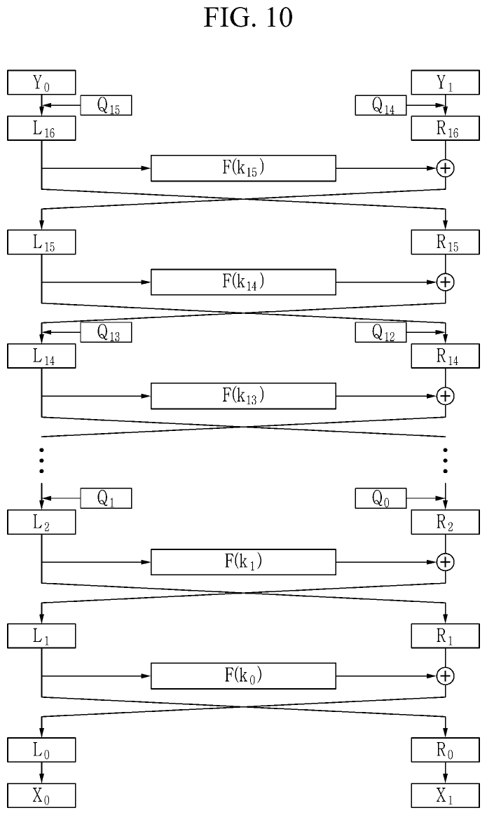

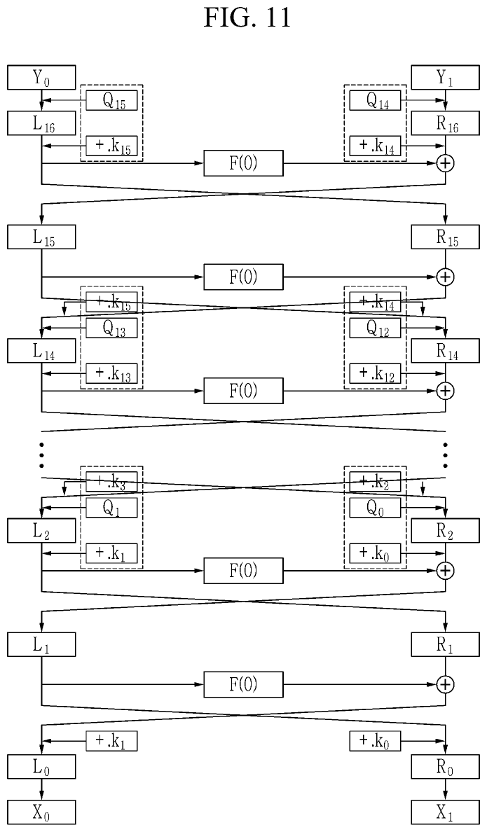

FIG. 9 is a flowchart illustrating a SEED encryption algorithm according to an exemplary embodiment, FIG. 10 is a flowchart illustrating a SEED decrypting algorithm according to an exemplary embodiment, and FIG. 11 is a flowchart illustrating an eSEED decrypting algorithm according to an exemplary embodiment.

In FIG. 9 and FIG. 10, the round function F(kᵢ) of each round is an F function having a round key kᵢ as a coefficient. In addition, in FIG. 9 and FIG. 10, Lᵢ is the output of the i^{th} encryption/decryption round, and when the size of the input block to the encryption function or the decryption function is 128 bits, it represents the left 64-bit part. Further, in FIG. 9 and FIG. 10, Rᵢ is the output of the i^{th} encryption/decryption round, and when the size of the input block to the encryption function or the decryption function is 128 bits, it represents the right 64-bit part.

According to an exemplary embodiment, in the eSEED encryption algorithm, Equation 20 and Equation 21 below are further performed after the i=2, 4, . . . , 16-th round operation performed in the SEED encryption algorithm.

L₂ᵢ→P₂ᵢ₊₁(L₂ᵢ) [Equation 20]

R₂ᵢ→P₂ᵢ(R₂ᵢ) [Equation 21]

That is, according to Equation 20 and Equation 21, the transformation Pᵢ, i=0, 1, . . . , 15 is applied, and a 64-bit bit string is transformed into another 64-bit string. The eSEED algorithm shown in FIG. 11 may be expressed as Equation 22.

$$Encryption by eSEED \text{:} \\ {L}_{0} = {X}_{0} ; \\ {R}_{0} = {X}_{1} ; \\ for ( i = 0 ; i < 16 ; i ++ ) \{ \\ if i * \{ 2 , 4 , 6 , 8 , 10 , 12 , 14 \} \{ \\ {L}_{i + 1} = {P}_{i - 2} ( {R}_{i} ) ; \\ {R}_{i = 1} = F ( {k}_{i} ) ( {P}_{i - 2} ( {R}_{i} ) ) ⊕ {P}_{i - 1} ( {L}_{i} ) ; \\ \} \\ else \{ \\ {L}_{i + 1} = {R}_{i} ; \\ {R}_{i + 1} = F ( {k}_{i} ) ( {R}_{i} ) ⊕ {L}_{i} ; \\ \} \\ \} \\ {Y}_{0} = {P}_{15} ( {L}_{16} ) ; \\ {Y}_{1} = {P}_{14} ( {R}_{16} ) ; \qquad [ Equation 22 ]$$

The transformation Pᵢ, i=0, 1, . . . , 15 may be generated using an auxiliary secret key A, B, U, V with a length of 128 bits. The auxiliary secret key A, B, U, V may be arbitrarily determined by the user like the secret key K.

16 64-bit auxiliary round keys aᵢ, bᵢ, uᵢ, vᵢ, i=0, 1, . . . , 15 may be generated by applying the Roundkey Generation method, which is a method for generating the round key kᵢ, i=0, . . . , 15 from the secret key K, to each auxiliary secret key A, B, U, V. At this time, the LSB of the 64-bit auxiliary round key aᵢ, bᵢ, uᵢ, vᵢ is all set to 1. In other words, Equation 23 is established.

LSB of aᵢ, bᵢ, uᵢ, vᵢ=1 for i=0, 1, . . . , 15 [Equation 23]

The transformation that performs one-to-one transformation from a 64-bit bit string to another 64-bit bit string may be defined as Equation 24 below.

Pᵢ(x)=P_{i,1}(P_{i,0}(x)⊕s)) [Equation 24]

In Equation 24, s is a 64-bit bit string, and P_{i,0} and P_{i,1} are transformations that transform an arbitrary 64-bit bit string to another 64-bit bit string. The inverse transformation Qᵢ of the transformation Pᵢ may be defined as Equation 25 and Equation 26 below.

$$\begin{matrix}\begin{matrix}{Q}_{i , 0} ( x ) = {P}_{i , 1}^{- 1} ( x ) \\ = ( ( ( ( ( ( ( ( ( ( x ⊗ {a}_{i} ) \times {b}_{i} ) ⊕ {u}_{i} ) + {v}_{i} ) \times {a}_{i} ⊕ {b}_{i} ) + \\ {u}_{i} ⊗ {v}_{i} ) ⊕ {a}_{i} ) + {b}_{i} ⊗ {u}_{i} ) \times {v}_{i} ) + {a}_{i} ⊗ {b}_{i} ) \times {u}_{i} ⊕ {v}_{i}\end{matrix} & [ Equation 25 ] \\ \begin{matrix}{Q}_{i , 1} ( x ) = {P}_{i , 0}^{- 1} ( x ) \\ = ( ( ( ( ( ( ( ( ( ( x ⊗ {v}_{i} ) \times {u}_{i} ) ⊕ {b}_{i} ) + {a}_{i} ) \times {v}_{i} ⊕ {u}_{i} ) + \\ {b}_{i} ⊗ {a}_{i} ) ⊕ {v}_{i} ) + {u}_{i} ⊗ {b}_{i} ) \times {a}_{i} ) + {v}_{i} ⊗ {u}_{i} ) \times {b}_{i} ⊕ {a}_{i}\end{matrix} & [ Equation 26 ]\end{matrix}$$

In Equation 25 and Equation 26, Q_{i,0} and Q_{i,1} may exist based on the condition of Equation 23. Further, the 64-bit bits string of 8 in Equation 24, which is additional information indicating the electronic signature, may be expressed as Equation 27.

s=SIGN_{Server}(P_{1,0}(L₂), P_{0,0}(R₂), ID_{Client}, Time) [Equation 27]

In Equation 27, the additional information s may be determined based on an intermediate calculation result of the plaintext to be encrypted (P_{1,0}(L₂) P_{0,0}(R₂)), a user identifier (ID_{Client}), time information (Time), and a value derived from the electronic signature of the server (e.g., in the case of 1024-bit electronic signature, the XOR values of the bit strings separated by 64 bits). That is, the additional informations is information that depends on the plaintext to be encrypted, the identifier of the user, and the time at which decrypting is possible, and may be generated by the server generating the cryptogram. Here, the electronic signature may be generated by a general-purpose electronic signature method.

Referring to FIG. 9, the transformation Pᵢ, i=0, 1, . . . , 15 is defined according to Equations 26 and 27 by the auxiliary round key aᵢ, bᵢ, uᵢ, vᵢ of the auxiliary secret key A, B, U, V. The transformation Pᵢ, i=0, 1, . . . , 15 and the round key kᵢ, i=0, . . . , 15 of the secret key K may be used sequentially in the round encryption process where the 128-bit plaintext X=(X₀, X₁) is transformed to the 128-bit cryptogram Y=(Y₀, Y₁) by the SEED encryption algorithm.

The encryption process in which the eSEED encryption algorithm using the auxiliary secret key encrypts the plaintext X and outputs Y is as shown In Equation 28 below.

Y=E*_{K;A,B,U,V;s}(X) [Equation 28]

In Equation 28, the additional information s may be publicly transmitted to the user along with cryptogram Y.

The following describes the decrypting process of the cryptogram Y into the plaintext X by the eSEED decrypting algorithm. Referring to FIG. 10, the round key kᵢ, i=15, 14, . . . , 0 and the inverse transformation Qᵢ of the transformation defined by the auxiliary round key aᵢ, bᵢ, uᵢ, vᵢ of the auxiliary secret key A, B, U, V may be used sequentially in the decryption process in which the 128-bit cryptogram Y=(Y₀, Y₁) is transformed to the 128-bit plaintext X=(X₀, X₁) by the SEED decrypting algorithm. The symbol +. of FIG. 10 is a symbol used in place of the XOR symbol ⊕.

The SEED decrypting algorithm according to an exemplary embodiment shown in FIG. 10 may be expressed by Equation 29 below based on the inverse transform Qᵢ of the transform Pᵢ.

$$\begin{matrix}Decryption by eSEED \text{:} \\ {L}_{16} = {Q}_{15} ( {Y}_{0} ) ; \\ {R}_{16} = {Q}_{14} ( {Y}_{1} ) ; \\ for ( i = 0 ; i < 16 ; i ++ ) \{ \\ if i * \{ 1 , 3 , 5 , 7 , 9 , 11 , 13 \} \{ & [ Equation 29 ] \\ {L}_{16 - i - 1} = {Q}_{16 - i - 2} ( F ( {k}_{16 - i - 1} ) ( {L}_{16 - i} ) ⊕ {R}_{16 - i} ) ; \\ {R}_{16 - i - 1} = {Q}_{16 - i - 3} ( {L}_{16 - i} ) ; \\ \} & \\ else \{ \\ {L}_{16 - i - 1} = F ( {k}_{16 - i - 1} ) ( {L}_{16 - i} ) ⊕ {R}_{16 - i} ; \\ {R}_{16 - i - 1} = {L}_{16 - i} ; \\ \} \\ \} \\ {X}_{0} = {L}_{0} ; \\ {X}_{1} = {R}_{0} ; & \end{matrix}$$

In Equation 29, the transform Qᵢ is the inverse transform of the transform Pᵢ, and may be expressed as Equation 30 by Equation 24.

Qᵢ(x)=Q_{i,1}(Q_{i,0}(x)⊕s) [Equation 30]

In the block cipher algorithm using the auxiliary secret key according to the exemplary embodiment, the round key kᵢ calculated from the secret key K and secret key K of the decryption process may be safely hidden in the decrypting program installed in the whitebox environment. The decrypting method using the auxiliary secret key according to the exemplary embodiment may separate the round key kᵢ, i=0, . . . , 15 of the secret key K from the F function, which is a round function, and perform the XOR operation on the separated round key kᵢ, i=0, . . . , 15 and the output of each round.

Referring to FIG. 10, Round L₁₆ is input to the round function F(k₁₅) and then operated with the round key by the round function F(k₁₅). But referring to FIG. 11, the Round key k₁₅ is separated from the round function F and XORed with Round L₁₆ (+. k₅ in FIG. 11). At this time, F(k₁₅) is replaced by F(0), where ‘0’ of F(0) is a bit string consisting of 64 zeros. In addition, an XOR operation between the output of the Round 15 and k₁₅ is added so that the XOR with k₁₅ can be removed before the Round L14 is generated by applying the transformation Q₁₃ to the output of Round 15 (+. k₁₅ above the Q₁₃ box in FIG. 11). Referring to FIG. 11, the XOR operation with the round key is added before the inverse transformation Qᵢ is applied to the input (i.e., the output of the odd round) toward the even round such as Round 11, Round 14, Round 2, etc. Another XOR operation with the next round key is added to the output of each even round. At this time, in order to prevent the round key kᵢ from being exposed by the newly added XOR operation, the decrypting method using the auxiliary secret key according to the exemplary embodiment may combine the XOR operation added in the decrypting program with the inverse transform Qᵢ. The combination of the added XOR operation and the inverse transform Qᵢ may be included in the program source code in the form of a lookup table (Look Up table, LUT). Therefore, the eSEED decrypting device according to the exemplary embodiment may read the LUT from memory and perform the added XOR operation and the inverse transform Qᵢ operation.

On the other hand, XOR with round keys k₀ and k₁ of the eSEED decrypting algorithm according to an exemplary embodiment is difficult to be hidden because it is operated separately without being combined with other transforms or functions (i.e., because it is independently positioned in the decrypting program). Therefore, k₀ and k₁ may be set to 0 when generated by the Roundkey generation method (i.e., k₀=k₁=0). If k₀ and k₁ are set to 0, even if k₀ or k₁ is exposed on the decrypting algorithm, the risk of other round keys k₂, k₃, . . . , k₁₅ being exposed can be blocked.

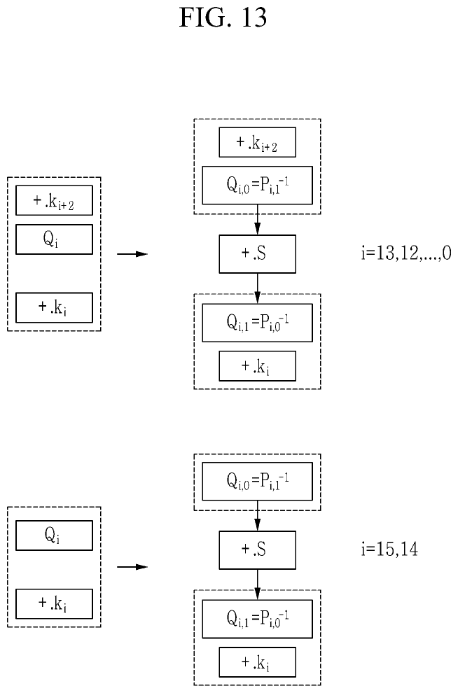

The decrypting method using the auxiliary secret key according to an exemplary embodiment may replace the round function operation with the XOR operation between one output of each round and round key by performing the XOR operation between the outputs of each round and the round key used in the round function of the decrypting algorithm. The decrypting method according to the exemplary embodiment may combine added XOR operation with the inverse transformation of the decrypting algorithm by loading the added XOR operation into the program source code in the form of the LUT. The decrypting method according to the exemplary embodiment using the above method may conceal the round key kᵢ of the secret key K and the auxiliary round key aᵢ, bᵢ, uᵢ, vᵢ of the auxiliary secret key A, B, U, V the program. The method of loading the added XOR operation in the program source code in the form of LUT is described in detail through FIG. 13.

In FIG. 11, when the round key kᵢ is extracted from the round function F and redistributed, the output Lᵢ and Rᵢ of each round may proceed differently from FIG. 10. That is, The output Lᵢ and Rᵢ of each round in FIGS. 10 and 11 may be different in some rounds. However, the final decrypting result may be the same.

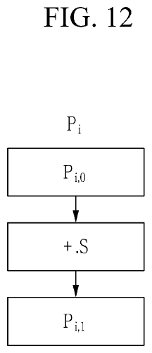

FIG. 12 is a schematic diagram illustrating the transformation Pᵢ of the eSEED decrypting algorithm according to an exemplary embodiment and FIG. 13 is a schematic diagram illustrating the combination between the XOR operation and the inverse transformation Qᵢ of the eSEED decrypting algorithm according to the exemplary embodiment.

FIG. 12 shows a function Pᵢ, i=0, 1, . . . , 15 that transforms 64 bits of the eSEED encryption algorithm to 64 bits. In the right drawing in FIG. 13, the dotted line box that encloses the inverse transformation Qᵢ, ‘+.kᵢ₊₂₋’, and ‘+.kᵢ₋’ is the part represented by the LUT. Specifically, the eSEED decrypting method according to the exemplary embodiment may use an LUT (size is 256bytes) that transforms 8 bits to 8 bits. The size of the LUT may be calculated as Equation 31.

$$\begin{matrix}256 = 16 \times & ( number of Rounds ) \\ 2 \times & ( per each {Q}_{i} ( {Q}_{i , 0} , {Q}_{i , 1} ) ) \\ 8 & ( required for transformation of 64 bits bit \\ & strings )\end{matrix} \qquad [ Equation 31 ]$$

Although four LUTs are used in the conventional SEED cipher, a very large number of LUTs are used in the key concealment method using the conventional LUT, so the decrypting method according to an exemplary embodiment may use fewer LUTs compared to the key concealment method using the conventional LUT, so that the key is effectively concealed.

According to an exemplary embodiment, the set of LUTs used to perform the calculation of the inverse transform Q_{i,0}, i=0, 1, . . . , 15 is recorded in a 3D array Q0 of which data type is ‘unsigned char’:

unsigned char Q0[16][8][256];

Here, the two-dimensional array Q0[i] may indicate the set of the LUTs used to calculate the transformation Q_{i,0}.

Then, the set of the LUTs used to perform the calculation of the transformation Q_{i,1}, i=0, 1, . . . , 15 is recorded in a 3D array Q1 of which data type is ‘unsigned char’:

unsigned char Q1 [16][8][256];

Here, the two-dimensional array Q1[i] may indicate the set of the LUTs used to calculate the transformation Q_{i,1}.

The process of calculating 64 bits Q_{i,0}(x) from 64 bits x may be described as LUT by the following method. First, as 64-bit x is represented as a joint of eight 8-bit x⁽⁷⁾, . . . , x⁽⁰⁾ (see Equation 14), 64-bit Q_{i,0}(x) is represented as a joint of eight 8-bit Q_{i,0}(x)⁽⁷⁾, . . . , Q_{i,0}(x)⁽⁰⁾ as shown In Equation 32 below.

Q_{i,0}(x)=(Q_{i,0}(x)⁽⁷⁾, . . . , Q_{i,0}(x)⁽⁰⁾) [Equation 32]

In Equation 25, Q_{i,0}(x) may be independently calculated in 8-bit unit, and the calculation of Q_{i,0}(x)^{(j)} may depend on x^{(j)}. That is, for the j=0, 1, . . . , 7, Q_{i,0}(x) may be calculated according to which 8 bits information Q_{i,0}(x)^{(j)} is transformed from 8 bits information x^{(j)}.

Specifically, 8-bit information Q_{i,0}(x)^{(j)} for 8-bit information x^{(j)} may be calculated as Equation 33 below in which Equation 25 is calculated by 8-bit unit.

$$\begin{matrix}{{Q}_{i , 0} ( x )}^{( j )} = ( ( ( ( ( ( ( ( ( ( {x}^{( j )} ⊗ {a}_{i}^{( j )} ) \times {b}_{i}^{( j )} ) ⊕ {u}_{i}^{( j )} ) + {v}_{i}^{( j )} ) \times \\ {a}_{i}^{( j )} ⊕ {b}_{i}^{( j )} ) + {u}_{i}^{( j )} ⊗ {v}_{i}^{( j )} ) ⊕ {a}_{i}^{( j )} ) + {b}_{i}^{( j )} ⊗ {u}_{i}^{( j )} ) \times \\ {v}_{i}^{( j )} ) + {a}_{i}^{( j )} ⊗ {b}_{i}^{( j )} ) \times {u}_{i}^{( j )} ⊕ {v}_{i}^{( j )}\end{matrix} \qquad [ Equation 33 ]$$

According to Equation 33, LUT Q0[i][j] may be expressed as Equation 34 below.

Q0[i][j][x^{(j)}]=Q_{i,0}(x)^{(j)} [Equation 34]

When Equation 34 is applied to i=0, 1, . . . , 15 and j=7, 6, . . . , 0, 3D array Q0, which is a set of LUTs used to perform the calculation of the transformation Q_{i,0}, i=0, 1, . . . , 15, can be calculated.

The same method is applied to Q_{i,1}, so that the 3D array Q1, which is the set of the LUTs used to perform the calculation of the transformation Q_{i,1}, i=0, 1, . . . , 15 is calculated.

Hereinafter, 3D arrays P0 and P1 representing a set of LUTs used for calculating transformation P_{i,0} and P_{i,1} of an eSEED encryption method according to an exemplary embodiment will be described.

unsigned char P0[16][8][256];

Transformation P_{i,0} and P_{i,1} are the inverse transformation of Q_{i,0} and Q_{i,1}, respectively, and each of the transformation Q_{i,0} and Q_{i,1} is group of one-to-one transformations that are independently calculated by 8 bits. Therefore the transformation P_{i,0} and P_{i,1} may be calculated from the inverse transform of the one-to-one transforms calculated independently by 8 bits.

P_{i,0}(x)^{(j)}=y^{(j)} if Q_{i,0}(y)=x [Equation 35]

P_{i,1}(x)^{(j)}=y^{(j)} if Q_{i,1}(y)=x [Equation 36]

LUT P0[i][j] for P_{i,0}(x)^{(j)}=y^{(j)} of Equation 35 may be calculated as Equation 37 below.

P0[i][j][Q0[i][j][n]]=n, n=0, 1, . . . 255 [Equation 37]

With the same method, LUT P1[i][j] for P_{i,1}(x)^{(j)}=y^{(j)} of Equation 36 may be calculated as Equation 38 below.

P1[i][j][Q1[i][j][n]]=n, n=0, 1, . . . , 255 [Equation 38]

When Equation 37 and Equation 38 are applied to i=0, 1, . . . , 15, and j=7, 6, . . . , 0, 3D arrays P0 and P1, which are the set of the LUTs used to perform the calculation of the transformation P_{i,0}, P_{i,1}, i=0, 1, . . . , 15, may be calculated.

3D arrays P0 and P1 may be used in the eSEED encryption process. On the other hand, 3D arrays Q0 and Q1 may be used in combination with XOR operation with round key kᵢ of secret key K during the eSEED decrypting process. In this case, the LUT Q0[i][j] for i=15, 14 is excluded from the combination with the XOR operation. The set of the LUTs used in the eSEED decryption process:

unsigned char QK0[16][8][256];

unsigned char QK1[16][8][256];

may be calculated according to Equation 39 below.

$$if i == 14 or 15 \\ for j = 7 , 6 , … , 0 \\ QK 0 [ i ] [ j ] [ n ] = Q 0 [ i ] [ j ] [ n ] ; \\ QK 1 [ i ] [ j ] [ n ] = Q 1 [ i ] [ j ] [ n ] ⊕ {k}_{i}^{( j )} ; \\ else \\ for j = 7 , 6 , … , 0 \\ QK 0 [ i ] [ j ] [ n ] = Q 0 [ i ] [ j ] [ n ⊕ {k}_{i + 2}^{( j )} ] ; \\ QK 1 [ i ] [ j ] [ n ] = Q 1 [ i ] [ j ] [ n ] ⊕ {k}_{i}^{( j )} ; \qquad [ Equation 39 ]$$

In Equation 39, QK1[i][j] is the LUT that performs the calculation of Q_{i,1}(x)^{(j)}⊕kᵢ, and QK0[i][j] is the LUT that performs the calculations of Q_{i,0}(x)^{(j)} in the case of i'14, 15 and Q_{i,0}(x⊕kᵢ₊₂)^{(j)} the case of i=0, 1, . . . , 13.

If 3D arrays QK0 and QK1 are used as they are in the source code of the eSEED decrypting program, there is a risk that the entire set of LUTs QK0 and QK1 are exposed by a memory hacking attack. To prevent this, in the eSEED decrypting method according to an exemplary embodiment, the added XOR operation may be installed in the source code of the program through the following LUT scrambling method.

### LUT Scrambling

First, 3D arrays QK0 and QK1 are represented by 65,536(=2¹⁶) variables. Specifically, 3D array QK0 is replaced with a variable by recording the value of Q0[i][j][n] into a randomly selected variable among variables listed from Q_00000 to Q_65535. For example, in typical source code, a 3D array may be represented in a form below.

unsigned char Q0[2][3]={0x2f, . . . , };

However, in the source code in the program of the eSEED decrypting method according to an exemplary embodiment, the 3D array may be represented in a form below.

unsigned char Q_00000=0x17;

unsigned char Q_12345=0x2f;

(When the variable selected for Q0[2][3][0] is Q_12345)

unsigned char Q_65535=0x12;

That is, it may be represented as a list of 65536 variables. At this time, variables selected for each of Q0[i][j][n] and Q1[i][j][n] may be recorded in a Dictionary. For example, a variable selected for 3D array Q0[2][3][0] may be recorded in the Dictionary as follows.

Dictionary[‘Q0[2][3][0]’]=‘Q_12345’;

(When the variable selected for Q0[i][3][0] is Q_12345)

2) According to an exemplary embodiment, when a bijective function ϕ that transforms 8 bits to 8 bits is represented using LUT Q0[2][3], b=ϕ(a) (where a and b are 8-bit integers) may be generally represented on the source code as Equation 40 below.

b=Q0[2][3][a]; [Equation 40]

In the program of the eSEED decrypting method according to an exemplary embodiment, b=ϕ(a) may be represented by using 256 ‘if’s as Equation 41 below through the LUT scrambling.

$$if a == 0 \times 00 \\ b = Q 0 [ 2 ] [ 3 ] [ 0 \times 00 ] ; \\ if a == 0 \times 01 \\ b = Q 0 [ 2 ] [ 3 ] [ 0 \times 01 ] ; \\ … \\ if a == 0 \times ff \\ b = Q 0 [ 2 ] [ 3 ] [ 0 \times ff ] ; \qquad [ Equation 41 ]$$

3) In the program of eSEED decrypting method according to an exemplary embodiment, the above source code may be represented as Equation 42 below through arbitrary adjustment of the order of if statements and variable renaming. Referring to Equation 42, the part about variable b (e.g., ‘b=Q0[2][3][0x00]’) indicating the LUT in Equation 41 may be replaced with a variable name having a form of ‘Q_abcde’ by using Dictionary, and the part related to the variable a may be replaced with a variable of the type ‘Q_abcde’ having a corresponding value.

$$\begin{matrix}if a == Q\_ 20123 & ( when Q\_ 20123 = 0 \times a 0 ) \\ b = Dictionary [ & ‘ Q 0 [ 2 ] [ 3 ] [ 0 \times a 0 ] ’ ] ; \\ if a == Q\_ 00724 & ( when Q\_ 00724 = 0 \times 0 \; 7 ) \\ b = Dictionary [ & ‘ Q 0 [ 2 ] [ 3 ] [ 0 \times 0 \; 7 ] ’ ] ; \\ . . . & \end{matrix} \qquad [ Equation 42 ]$$

Next, a 64-bit bit string s of encrypting and decrypting method of the eSEED according to an exemplary embodiment will be described. Referring to Equation 27, s is information depending on a plaintext to be encrypted, an identifier of a user who decodes a cryptogram, and a time at which decrypting is possible, and may be generated by the server generating the cryptogram.

The eSEED decrypting method according to an exemplary embodiment may determine whether to continue decrypting by verifying the electronic signature of the server. This may be expressed by Equation 43 below.

[Equation 43]

then eSEED stops.

In Equation 43, P_{1,0}(L₂) and P_{0,0}(R₂) may be calculated by Equation 44 below.

P_{1,0}(L₂)=LUT_{Q}_{_{1,0}}_{, k}_{₃}(F(0)(L₃)⊕R₃)

P_{0,0}(R₂)=LUT_{Q}_{_{0,0}}_{, k}_{₂}(L₃) [Equation 44]

In Equation 44, LUT_{Q}_{_{1,0}}_{, k}_{₃} indicates that the method of applying the transformation Q_{1,0} to the XOR result of k₃ is performed by the LUT. LUT_{Q}_{_{0,0}}_{, k}_{₂} may be explained in the the same way.

The eSEED decrypting method according to the exemplary embodiment may obtain the following effects by setting the verification of the electronic signature as an essential step.

a) The eSEED decrypting method may implement the ‘location limitation’ function in the decrypting program by setting the verification of the electronic signature as an essential step. That is, in the eSEED decrypting method according to an exemplary embodiment, the electronic signatures may be used to control the eSEED decrypting program so that the user's identifier ID_{Client} cannot be used in another terminal.

b) The eSEED decrypting method may implement the ‘time limit’ function in the decrypting program by setting the verification of the electronic signature s as an essential step. That is, the eSEED decrypting method according to an exemplary embodiment may control such that the eSEED decrypting program operates only within a predetermined time range (Time). For example, decrypting using the encrypted information Y′ purchased in the past outside of a predetermined time range and its electronic signature s′ may be used to perform Rounds before Rounds L₂ and R₂. However, since the time range inherent in the s′ does not include the time at which decrypting is performed, the rest of the decryption process is not performed and is interrupted, so that decrypting of Y′ cannot be completed. At this time, since the encrypted information Y′ purchased in the past may be decrypted at the time of the purchase in the past according to the application field of the eSEED decryption method according to an exemplary embodiment (for example, the multimedia content protection field), and may be hidden as a decryption result, the user cannot use the past decoding result at the present time. Therefore, the ‘time limit’ function of the eSEED decoding program may be required.

c) The eSEED decrypting method may prevent the electronic signature s from being reused by setting the verification of s as an essential step. Referring to Equation 28, the electronic signature s depends on the original data and may also be used in the decryption process. Therefore, another s′ cannot be used to decode cryptograms Y that depend on the s.

Above, the component elements of this description were specifically described based on exemplary embodiments and drawings. However, the exemplary embodiments and drawings provided above are only to help the overall understanding of the present description, and the present description is not limited to the above exemplary embodiments. For example, 256 LUTs are used in the present description, but the number of LUTs can be increased to further secure stability against a memory hacking attack for the LUT. Methods that use more LUTs may include increasing the number of auxiliary secret keys, increasing the number of operations between 8 bits, or transforming the transformation Qᵢ by changing the arrangement order of round keys as shown In Equation 45 below.

Qᵢ(x)=Q_{i,n}(Q_{i,n-1}(. . . (Q_{i,0}(x)⊕s)⊕s . . . )⊕s) [Equation 45]

In the above, the eSEED decrypting method according to an exemplary embodiment in which the round key of secret key K is hidden in the decrypting program by combining with the transformation Qᵢ defined by the auxiliary secret key is described. In the following, a method of concealing the round key information of the secret key in the eDES decrypting program is described.

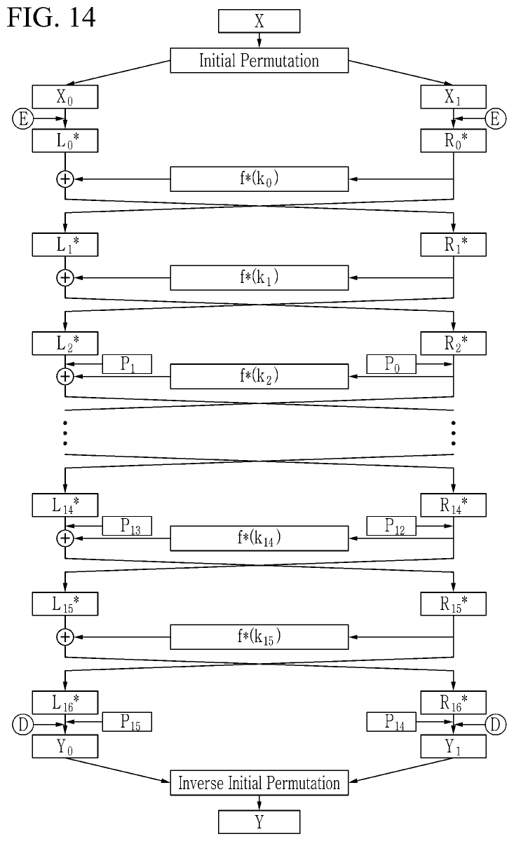

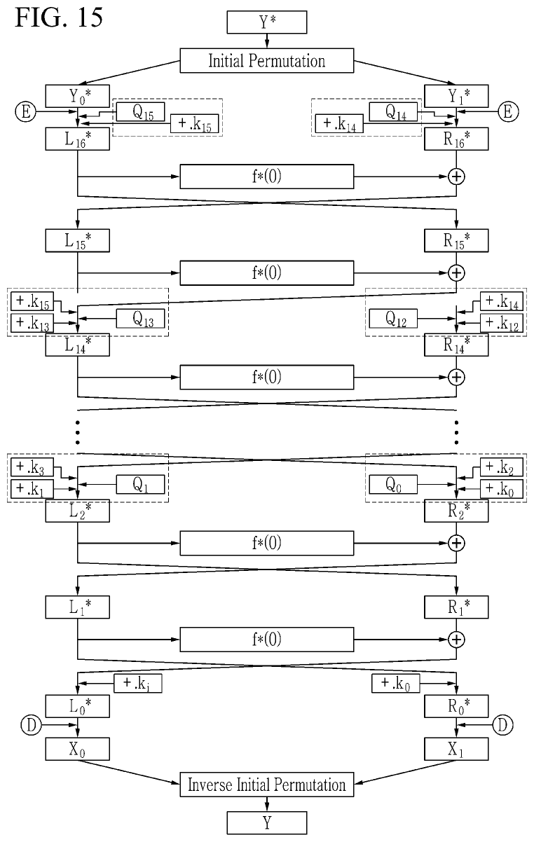

FIG. 14 is a schematic diagram illustrating an eDES encryption method according to an exemplary embodiment, and FIG. 15 is a schematic diagram illustrating an eDES decrypting method according to an exemplary embodiment.

Since the structure of DES is the same as that of SEED, the DES encryption method may be transformed as FIG. 14. In FIG. 14, ‘E’ performed on inputs X₀ and X₁ is an expansion transformation used in the Feistel function of the DES cipher, and D is the left inverse transform of transformation E that extends a 32-bit bit string to a 48-bit bit string. In addition, f* is a function which the Feistel function f of the DES is modified by Equation 7. In the eDES encryption method, the length of each round Lᵢ and Rᵢ is 48 bits.

Referring to FIG. 14, The transformation Pᵢ, i=0, 1, . . . , 15 defined by the auxiliary round key of the auxiliary secret key and the round key kᵢ, i=0, 1, . . . , 15 of the secret key K are used sequentially within the round eDES encryption method to transform a 64-bit plaintext into a 64-bit cryptogram.

The transformation Qᵢ=Pᵢ⁻¹ of eDES may be generated according to Equations 25 and 26 by using the auxiliary round keys aᵢ, bᵢ, uᵢ, vᵢ generated from the auxiliary secret keys A, B, U, V. In the eSEED, an auxiliary round key with a length of 64 bits is generated from an auxiliary secret key with a length of 128 bits, and the transformation Qᵢ transforming a 64-bit to a 64-bit by using the 64-bit auxiliary round keys is generated. In the eDES, an auxiliary round key with a length of 48 bits is generated from an auxiliary secret key with a length of 56 bits, and a transformations Qᵢ transforming 48 bits to 48 bits based on the 48-bit auxiliary round key may be generated.

FIG. 15 is a schematic diagram illustrating the decrypting method of the eDES. In the eDES decrypting method, the round key kᵢ is extracted from the f * function and then combined with the function Qᵢ, i=15, 14, . . . , 0. That is, the round key of the secret key and the transformation Qᵢ, i=15, 14, . . . , 0 defined by the auxiliary round key of the auxiliary secret key are sequentially used in the eDES decrypting method, and thus can transform a 64-bit cryptogram Y* into a 64-bit plaintext X. In FIG. 15, the symbol +. is used instead of the XOR symbol ⊕. D is the left inverse transform of transformation E which extends a 32-bit bit string to a 48-bit bit string.

At the end of the eDES decrypting method of FIG. 15, the XOR operation of the round keys k₀ and k₁ is independently positioned for the transformation Qᵢ, making it difficult to be concealed. Therefore, round keys k₀ and k₁ are calculated by the Roundkey generation method and then set to 0 (k₀=k₁=0), so that other round keys k₂, k₃, . . . , k₁₅ are safe from being exposed although the round keys k₀ and k₁ are exposed.

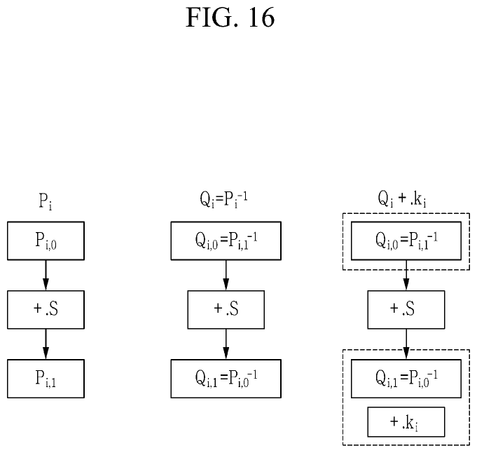

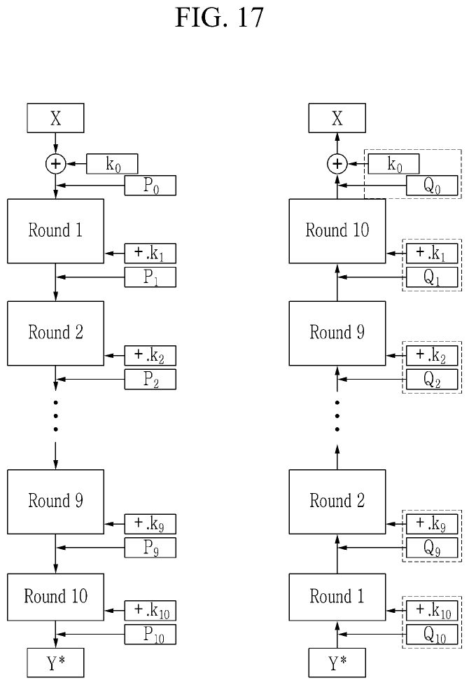

FIG. 16 is a schematic diagram illustrating a transformation function of the eDES encryption method and a combination between the transformation function and the round key kᵢ according to an exemplary embodiment, and FIG. 17 is a schematic diagram illustrating a combination method between the transformation function of another eDES encryption method and the round key kᵢ according to another exemplary embodiment.

In FIG. 16, Pᵢ, i=0, 1, . . . , 15 is a transformation function that transforms 48 bits to another 48 bits used in the eDES encryption algorithm, and Qᵢ, i=0, 1, . . . , 15 is a transformation function that transforms 48 bits to other 48 bits used in the eDES decrypting algorithm. In FIG. 16, the part enclosed by dotted lines may correspond to one LUT. That is, referring to FIG. 16, since Qᵢ, i=0, 1, . . . , 15 is defined as the inverse transformation of Pᵢ, i=0, 1, . . . , 15 determined by the auxiliary round key aᵢ, bᵢ, uᵢ, vᵢ of the auxiliary secret key, the combination between the round key kᵢ of the secret key and Qᵢ, i=0, 1, . . . , 15 may be described as a combination between the round key kᵢ of the secret key and the auxiliary round key aᵢ, bᵢ, uᵢ, vᵢ of the auxiliary secret key. In FIG. 16, the part enclosed by dotted lines may be the part represented by one LUT.

In FIG. 17, a combination of a function Pᵢ, i=0, 1, . . . , 15 that transforms 128 bits to another 128bit, which is used in the eAES encryption method, a function Qᵢ, i=0, 1, . . . , 15 that transforms 128 bits to another 128 bits, which is used in the eAES decrypting method, and a round key kᵢ of the secret key is described. In FIG. 17, the part enclosed by dotted lines may be the part represented by one LUT.

In the eDES, the electronic signature s may be calculated using Equation 27 of the eSEED, and the ‘time limit’ effect and the ‘location limit’ effect may be obtained.

The following describes a method of concealing the round key information of the secret key in the decrypting program in the decrypting method of the eAES. The eAES algorithm may be described as a modification of the encryption process of the AES Based on FIG. 16. The transformation Qᵢ=Pᵢ⁻¹ used in the eAES may generate round keys aᵢ, bᵢ, uᵢ, vᵢ by using the auxiliary secret key, and may be generated based on the generated round keys according to Equation 25 and Equation 26.

In the eSEED, a round key with a length of 64 bits is generated from an auxiliary secret key with a length of 128 bits, and Qᵢ generated by using the generated round key is used to transform 64 bits to 64 bits. In the eAES, the length of the auxiliary secret key is the same as the length of the secret key (e.g., 128 bits), a round key with a length of 128 bits is generated from the auxiliary secret key, and Qᵢ generated by using the generated round key is used to transform 128 bits to 128 bits.

Referring to FIG. 17, The combination between the transformation function Qᵢ transforming 128-bit to 128-bit defined by the round key of the auxiliary secret key and the round key kᵢ of the secret key may be implemented in the form of the LUT in the decrypting program (the part enclosed by the dotted line in FIG. 17), after the round key kᵢ of the secret key is combined with the round key aᵢ, bᵢ, uᵢ, vᵢ of the auxiliary secret key, it can be concealed in the decrypting program. In the eAES, the electronic signature s may be calculated using Equation 27, where the ‘time limit’ effect and the ‘location limit’ effect can be obtained.

According to exemplary embodiments above, the round key of the secret key can be safely concealed in the decrypting program. In addition, by incorporating the LUTs used for concealment into the decrypting program in a scrambling manner, it is possible to prevent the LUTs from being exposed to the outside. Further, by verifying the digital signature received from the server during the decryption, the location limitation and the time limitation functions of the decrypting program can be implemented and reuse of the digital signature can be prevented.

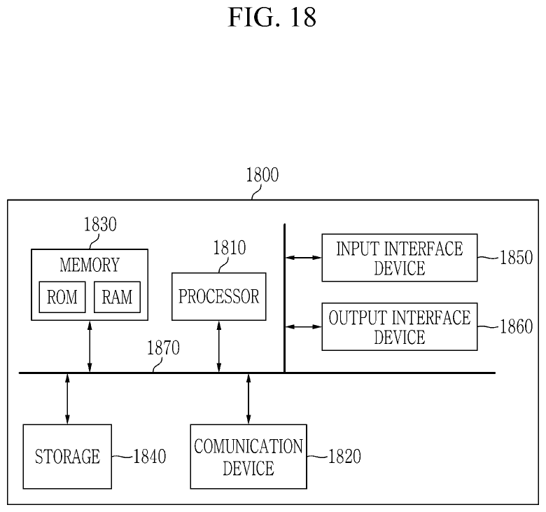

FIG. 18 is a block diagram illustrating a decrypting apparatus according to an exemplary embodiment.

The decrypting apparatus according to an exemplary embodiment may be implemented as a computer system, for example a computer readable medium. Referring to FIG. 18, a computer system 1800 may include at least one of processor 1810, a memory 1830, an input interface unit 1850, an output interface unit 1860, and storage 1840. The computer system 1800 may also include a communication device 1820 coupled to a network. The processor 1810 may be a central processing unit (CPU) or a semiconductor device that executes instructions stored in the memory 1830 or storage 1840. The memory 1830 and the storage 1840 may include various forms of volatile or non-volatile storage media. For example, the memory may include read only memory (ROM) 1831 or random access memory (RAM) 1832. In the exemplary embodiment of the present disclosure, the memory may be located inside or outside the processor, and the memory may be coupled to the processor through various means already known. Thus, the embodiments may be embodied as a computer-implemented method or as a non-volatile computer-readable medium having computer-executable instructions stored thereon. In the exemplary embodiment, when executed by a processor, the computer-readable instructions may perform the method according to at least one aspect of the present disclosure. The communication device 1820 may transmit or receive a wired signal or a wireless signal. On the contrary, the embodiments are not implemented only by the apparatuses and/or methods described so far, but may be implemented through a program realizing the function corresponding to the configuration of the embodiment of the present disclosure or a recording medium on which the program is recorded. Such an embodiment can be easily implemented by those skilled in the art from the description of the embodiments described above. Specifically, methods (e.g., network management methods, data transmission methods, transmission schedule generation methods, etc.) according to embodiments of the present disclosure may be implemented in the form of program instructions that may be executed through various computer means, and be recorded in the computer-readable medium. The computer-readable medium may include program instructions, data files, data structures, and the like, alone or in combination. The program instructions to be recorded on the computer-readable medium may be those specially designed or constructed for the embodiments of the present disclosure or may be known and available to those of ordinary skill in the computer software arts. The computer-readable recording medium may include a hardware device configured to store and execute program instructions. For example, the computer-readable recording medium can be any type of storage media such as magnetic media like hard disks, floppy disks, and magnetic tapes, optical media like CD-ROMs, DVDs, magneto-optical media like floptical disks, and ROM, RAM, flash memory, and the like. Program instructions may include machine language code such as those produced by a compiler, as well as high-level language code that may be executed by a computer via an interpreter, or the like. While this disclosure has been described in connection with what is presently considered to be practical example embodiments, it is to be understood that this disclosure is not limited to the disclosed embodiments, but, on the contrary, is intended to cover various modifications and equivalent arrangements included within the spirit and scope of the appended claims.

What is claimed is:

1. A decrypting apparatus in a block cipher system, the decrypting apparatus comprising:
a processor, a memory, and a wireless communication unit,
wherein the processor executes a program stored in the memory to perform:
dividing a cryptogram received from a server through the wireless communication unit into a first cryptogram and a second cryptogram;
transforming the first cryptogram and the second cryptogram by using a predetermined inverse transform; and
decrypting the cryptogram to generate a plaintext based on a Feistel network including XOR operations between the transformed first cryptogram and a round key generated from a secret key and between the transformed second cryptogram and the round key,
wherein the predetermined inverse transform is an inverse of a transform determined based on an auxiliary secret key having a same size as A size of the cryptogram and electronic signature, and the Feistel structure includes n round operations and n is a natural number.

2. The decrypting apparatus of claim 1, wherein:
when the processor performs the step of the transforming, the processor performs
transforming the first cryptogram and the second cryptogram by using the predetermined inverse transform and by reading a lookup table (LUT) from the memory, and
the XOR operations include a first XOR operation between the transformed first cryptogram and the round key and a second XOR operation between the transformed second cryptogram and the round key.

3. The decrypting apparatus of claim 2,
wherein the LUT is included in the program to indicate a combination of the XOR operations and the predetermined inverse transform.

4. The decrypting apparatus of claim 3,
wherein the LUT includes a plurality of 3D arrays, and the plurality of 3D arrays are included in the program in a LUT scrambling manner based on ordering of if statements and variable renaming.

5. The decrypting apparatus of claim 1,
wherein the processor executes the program to further perform
receiving the electronic signature from the server through the wireless communication unit,
wherein the electronic signature is determined based on intermediate calculation result of the plaintext, an identifier of a user using the decrypting apparatus, time information, and a value derived from the electronic signature of the server.

6. The decrypting apparatus of claim 5,
wherein the processor executes the program to further perform
determining whether to continue the decrypting by checking the electronic signature of the server.

7. The decrypting apparatus of claim 1, wherein
when the processor performs decrypting the cryptogram into a plaintext based on a Feistel network including XOR operations between the transformed first cryptogram and a round key generated from a secret key and between the transformed second cryptogram and the round key, the processor performs:
performing, in a 2m^{th} round, a first XOR operation between one output of a 2m+1^{th} round and a 2m+1^{th} round key;
applying an inverse transformation corresponding to the 2m+1^{th} round to a result of the first XOR operation; and
performing a second XOR operation between a result of the inverse transformation and a 2m−1^{th} round key,
wherein m is a natural number and 2m+1 is less than n.

8. The decrypting apparatus of claim 7, wherein:
when the processor performs decrypting the cryptogram into a plaintext based on a Feistel network including XOR operations between the transformed first cryptogram and a round key generated from a secret key and between the transformed second cryptogram and the round key, the processor further performs:
inputting a result of the second XOR operation to a round function corresponding to the 2m^{th} round in the 2m^{th} round; and
performing a third XOR operation between an output of the round function and one output of the 2m^{th} round.

9. The decrypting apparatus of claim 8,
wherein the round function has the same length as the first cryptogram, and all elements in the round function are 0.

10. The decrypting apparatus of claim 1,
wherein k₀ and k₁ of the round key are 0, and the k0 and k1 are used in an XOR operation performed at a last even numbered round.

11. A decrypting method in a block cipher system, the method comprising:
dividing a cryptogram received from a server into a first cryptogram and a second cryptogram;
transforming the first cryptogram and the second cryptogram by using a predetermined inverse transform; and
decrypting the cryptogram to generate a plaintext based on a Feistel network including XOR operations between the transformed first cryptogram and a round key generated from a secret key and between the transformed second cryptogram and the round key,
wherein the predetermined inverse transform is an inverse of a transform determined based on an auxiliary secret key having a same size as A size of the cryptogram and electronic signature, and the Feistel structure includes n round operations and n is a natural number.

12. The decrypting method of claim 11,
wherein the transforming the first cryptogram and the second cryptogram by using a predetermined inverse transform includes transforming the first cryptogram and the second cryptogram by using a lookup table (LUT) indicating a combination of the XOR operations and the predetermined inverse transform, and the LUT is included in a decrypting program.

13. The decrypting method of claim 12,
wherein the LUT includes a plurality of 3D arrays, and the plurality of 3D arrays is included in the decrypting program in a LUT scrambling manner based on ordering of if statements and variable renaming.

14. The decrypting method of claim 11, further comprising:
receiving the electronic signature from the server through the wireless communication unit,
wherein the electronic signature is determined based on intermediate calculation result of the plaintext, an identifier of a user using the decrypting apparatus, time information, and a value derived from the electronic signature of the server.

15. The decrypting method of claim 14, further comprising:
determining whether to continue the decrypting by checking the electronic signature of the server.

16. The decrypting method of claim 11,
wherein the decrypting the cryptogram into a plaintext based on a Feistel network including XOR operations between the transformed first cryptogram and a round key generated from a secret key and between the transformed second cryptogram and the round key includes:
performing, in a 2m^{th} round, a first XOR operation between one output of a 2m+1^{th} round and a 2m+1^{th} round key;
applying an inverse transformation corresponding to the 2m+1^{th} round to a result of the first XOR operation; and
performing a second XOR operation between a result of the inverse transformation and a 2m−1^{th} round key,
where m is a natural number and 2m+1 is less than n.

17. The decrypting method of claim 16,
wherein the decrypting the cryptogram into a plaintext based on a Feistel network including XOR operations between the transformed first cryptogram and a round key generated from a secret key and between the transformed second cryptogram and the round key further includes:
inputting a result of the second XOR operation to a round function corresponding to the 2m^{th} round in the 2m^{th} round; and
performing a third XOR operation between an output of the round function and one output of the 2m^{th} round.

18. The decrypting method of claim 17,
wherein the round function has the same length as the first cryptogram, and all elements in the round function are 0.

19. The decrypting method of claim 11,
wherein k₀ and k₁ of the round key are 0, and the k0 and k1 are used in an XOR operation performed at a last even numbered round.
